(19) United States
(12) Patent Application Publication
(10) Pub. No.: US 2006/0248235 A1
(43) Pub. Date: Nov. 2, 2006

(54) Method and apparatus for data collection in a media player

(75) Inventor: Mark Kenneth Eyer, Woodinville, WA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-Ku (JP); Sony Electronics Inc., Park Ridge, NJ (US)

(21) Appl. No.: 11/086,013

(22) Filed: Mar. 21, 2005

(51) Int. Cl. G06F 3/00

(52) U.S. Cl. 710/1

(57) ABSTRACT

One embodiment can be characterized as a method of data collection for a portable media player comprising receiving an input at the media player corresponding to a user interaction; storing data corresponding to the input; and providing the data corresponding to the input to a library manager present on an external device such as a personal computer. Another embodiment can be characterized as a media player device having data collection capabilities comprising an interface circuit for receiving an input corresponding to a user interaction; a processor circuit for monitoring the inputs; and a memory for storing data corresponding to the input, the data for use by a library manager.

### BACKGROUND OF THE INVENTION

1. Field of the Invention

The present invention relates to media players. More specifically, the present invention relates to data collection in a media player.

2. Discussion of the Related Art

Portable audio players are known in the art. Generally, a portable audio player stores audio files and allows a user to play back the audio files through a speaker, earpiece, or headphone system. Typically, the user's audio collection is created, managed, and maintained by a separate PC-based library management program. All or a selected subset of files in the user's audio collection are transferred to the portable player for later playback. Currently, when a user is listening to an audio file stored on the portable music player, if there is anything wrong or undesirable with the track, in order for a user to take action (for example, edit the track or remove the track from a playlist), the user needs to make a note of the track (for example, on a piece of paper) and later when interacting with the library management program make changes to the relevant audio file or files. This is inconvenient as it requires the user to remember to edit the track at a later time, possibly after the user has forgotten about the problem with the audio file.

### SUMMARY OF THE INVENTION

The present invention generally relates to recording user commands to a portable media player and utilizing the recorded commands to aid in effecting changes to the music library or to suggest changes that can be made to the music library.

One embodiment can be characterized as a method of data collection for a media player comprising receiving an input at the media player corresponding to a user interaction; storing data corresponding to the input; and providing the data corresponding to the input to a library manager.

Another embodiment can be characterized as a media player device having data collection capabilities comprising an interface circuit for receiving an input corresponding to a user interaction; a processor circuit for monitoring the inputs; and a memory for storing data corresponding to the input, the data for use by a library manager.

A subsequent embodiment can be characterized as a method of managing a media library comprising receiving data corresponding to an input received at a media player; and utilizing the data corresponding to the input received at the media player for aiding in editing of a media file.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating a computer coupled to an audio player in accordance with one embodiment;

FIG. 2 is a flow diagram illustrating a method of recording an event on an audio player in accordance with one embodiment; and

FIG. 3 is a flow diagram illustrating a method of receiving information from an audio player for use in editing a music library in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

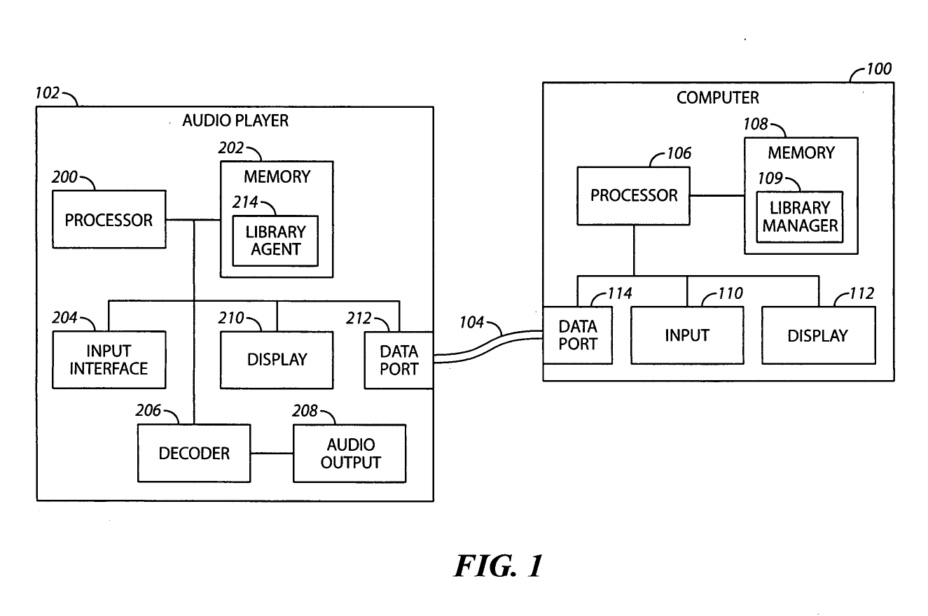

Referring to FIG. 1, shown is block diagram illustrating a computer 100 coupled to a portable audio player 102 in accordance with one embodiment. The computer 100 is coupled to the portable audio player 102 through a communication interface 104.

The computer 100 includes a processor 106, a memory 108, an input 110, a display 112, and a data port 114. It will be understood that the computer 100 can be one of many manufactured and sold computers widely available, including for example, a desktop computer, a laptop computer, a notepad, a pocket PC, or other type of electronic device regardless of the type of operating system supported by the computer. As will be described herein, the computer 100 is an electronic device that is capable, through a combination of hardware, firmware and/or software of managing a group of audio files (also referred to herein as a music library).

The portable audio player 102 includes a processor 200, a memory 202, an input interface 204, a decoder 206, an audio output 208, a display 210, a data port 212, and a Library Agent 214. The processor 200 is operably coupled to the memory 202, the input interface 204, the decoder, the display 210 and the data port 212. The portable audio player 102 stores audio files in the memory 202 in the form of audio data. The processor 200 controls reading the audio data into or out of the memory 202. The audio data output from the memory is provided to the decoder 206. The decoder 206 decodes the audio data and outputs the decoded audio data to the audio output 208. The audio output 208 (for example, headphones) outputs the audio data as an audible signal that is heard by the user of the portable audio player 102.

The memory 202 includes memory for storage of audio files and also includes program memory for storing, for example, the Library Agent 214. The Library Agent 214 is a program that is run by the processor 200. The Library Agent 214 will be described below in greater detail. The memory 202 is, for example, a built-in hard disk drive, non-volatile “flash” memory or any combination thereof. All or a portion of the memory may be in the form of one or more removable blocks, modules, or chips. The memory 202 need not be one physical memory device, but can include one or more separate memory devices. The audio output 208 is, for example, a speaker or an audio jack for use with a headphone set. The portable audio player 102 also sends and receives data communications to and from the computer 100 through data port 212 and the communication interface 104. In normal operation, the portable audio player is disconnected from the computer 100 and functions independently from it.

The communication interface 104, as shown, is a data line, such as a two-way communication bus or bi-directional data link through which data can be sent from the computer 100 to the portable audio player 102 and sent from the portable audio player 102 to the computer 100. The communication interface 104 is, for example, a universal serial bus (USB) interface or an iLink or an IEEE-1394 (“Firewire”) interface. In one embodiment, the communication interface 104 is a wireless interface over which data can be transferred back and forth between the computer 100 and the portable audio player 102. In this embodiment, the portable audio player 102 and the computer 100 both include transceivers used to transmit and receive data. For example, the data is sent and received from the transceivers utilizing the Bluetooth wireless communication standard.

The computer 100 is coupled to the portable audio player 102 through the communication interface 104. The computer 100 includes a Library Manager 109. In one embodiment, the Library Manager 109 is implemented as software stored in the memory 108 of the computer 100 and run by the processor 106 of the computer 100. One Library Manager 109 widely used is iTunes, however, other Library Managers are also available and known in the art. In operation, the Library Manager 109 displays an organized listing of the media files on a display 112 providing a user an interface for editing the media files or editing the attributes associated with the media files. The Library Manager includes logic that keeps track of where audio files are stored in the memory and displays data on the display 112 corresponding to the stored audio files. The following further examples of functions of the Library Manager 109 will be described in terms of audio files, however, the Library Manager 109 described herein manages media files (e.g., audio files, video files, picture files) in accordance with various embodiments. The Library Manager 109 provides a user interface for editing a music library of audio files, for example, adding or deleting songs from the music library, grouping songs within the music library, and creating playlists within the music library. As referred to herein, editing refers to any number of actions including, for example, any of the following: adjusting the sound volume of the recorded track as appropriate, trimming the beginning and/or ending portion of the track, changing the genre associated with the track or album, and deleting the track from the music library.

Generally, a music library is a collection of one or more songs from one or more artists. In many instances, the music library is a collection of thousands of songs from dozens of artists. Each song includes audio data and also includes meta data associated with the song. The meta data includes, for example, the name of the song, the artist, the album title, the genre and the time period from when the song was created. The Library Manager 109 reads the meta data and displays a sorted listing of songs on the display 112 that are grouped by, for example, artist, album, name, genre, or time period. For example, the Library Manager 109 shows a list of folders on the display 112, where files associated with a given artist are stored in a folder labeled with that artist's name. Within each folder is, in one embodiment, a list of sub folders, where each sub folder is an album name for the artist and within each sub folder is a list of songs contained on the album. As another example, the Library Manager 109 provides an alphabetical listing of all of the songs according to the name of the song within the music library on the display 112. The list of songs can also be sorted by, for example, artist, album name, or genre. It should be understood that these are only a few examples of the many features that different Library Manager 109 offers and that not all of the features are required for the implementation of the various embodiments described herein.

Typically, when in use, the portable audio player 102 is disconnected from the computer 100. As a user listens to music from the portable audio player 102, the user interacts with the portable audio player 102, for example, through the input interface 204 on the portable audio player 102. The input interface 204 includes, for example, a keypad, a touchpad, a microphone (for use with voice recognition), a touch screen or other types or devices used to interact with an electronic device. During playback, the user may interact with the portable audio player in a variety of ways, including to adjust the volume level up or down, to skip the currently-playing track, to fast-forward or fast-rewind through the musical selection, or to add the track to an on the fly playlist managed by the portable audio player 102. An on-the-fly playlist refers to a playlist that is created by a user on the portable audio player 102 and not on the computer 100. The portable audio player 102, in accordance with the present embodiment, stores a history of the interactions for later use by the Library Manager 109 on the computer 100. When the audio player 102 is playing a song, the input interface 204 may receive a user interaction. The Library Agent 214 monitors the interactions and, when such interaction occurs, initiates storing data that will be later used by the Library Manager 109 on the computer 100. The data is stored in the memory 202 of the portable audio player 102.

The audio player 102 includes the Library agent 214. The Library agent 214 represents a functional block within the audio player 102. The Library agent 214 is implemented, in one embodiment, as software stored in the memory 254 and executed by the processor 200. The Library agent 214 is also referred to herein the Library Agent circuitry 214. As described herein, those skilled in the art will appreciate that circuitry can refer to dedicated fixed-purpose circuits and/or partially or wholly programmable platforms of various types and that these teachings are compatible with any such mode of deployment for the Library agent 214. The Library Agent circuitry 214 is any type of executable instructions that can be implemented as, for example, hardware, firmware and/or software, or any combination thereof, which are all within the scope of the various teachings described.

In one embodiment, the data from the user interactions is utilized by the Library Agent 214 to edit the music library on the audio player. The editing can be done automatically by the Library Agent 214 or the Library Agent 214 can prompt a user to make changes to the music library. Additionally, the Library Agent 214 can flag songs that may need editing.

In one embodiment, the history of the interactions (i.e., the data that corresponds to user interactions) is stored as a single file in the memory 202 of the portable audio player 102. Alternatively, the history of the interactions is stored as meta data associated with one or more audio files. For example, a meta data file having the same name as an audio file with a different extension is used, in one embodiment, to store a history of interactions that took place with the audio file was playing. In yet another option, the history of the interactions is stored within one or more audio files. Regardless of how the information is stored, the Library Manager 109 on the computer 100 receives the history of interactions after the portable audio player 102 is reconnected to the computer 100. The interactions by a user generally include commands such as, for example, turning up or down the volume during a song, skipping a song, replaying a song or flagging a song. The portable audio player stores the history of at least some of the interactions and also stores data as to when the interactions took place, for example, what song was playing when the user causes the song to skip and what point within the song selection the command to skip took place. The history of interactions is stored such that they can be used by the Library Manager 109 to edit the music library or make changes to the contents of the library or aid a user in doing so. For example, the Library Manager 109 may delete a song from the music library if a user skips the song every time the song is played on the portable audio player 102.

In one embodiment, the portable audio player 102 records a history of all of the interactions that take place and provides all of the interactions to a Library Manager 109. In this example, the Library Manager 109 determines which of the interactions are more significant and thus, indicate that a modification to the music library may need to be made. Alternatively, the portable audio player 102 includes intelligence to differentiate between significant interactions (i.e., those that indicate a change to a song or the music library may need to be made) and less significant interactions. In this example, only the significant interactions are supplied to the Library Manager 109. For example, when the portable audio player is first turned on and a user skips the first 5 songs in a playlist and turns up the volume, this most likely indicates that a user is searching for a song and setting the volume to a desired level. These are insignificant interactions. However, if after five songs have been played, and a user skips the sixth song, this indicates, for example, that the user may not like that song and that he may wish the song to be removed from the playlist. Therefore, when the audio player includes intelligence to differentiate between interactions, only the “skip track” interaction will be stored and provided to the Library Manager 109. Thus, the intelligence for what the different user interactions may mean can be implemented on either the portable audio player 102 or the computer 100, or some portions on both, in different embodiments.

As stated above, the interactions of a user with the portable audio player, received as inputs through the input interface 204, are utilized by the Library Manager 109 after the portable audio player 102 is reconnected to the computer 104 after a period of use. The Library Manager 109 interprets the interactions and, in one embodiment, prompts a user to make changes to the music library. Alternatively, the Library Manager 109 can automatically make changes to the music library without prompting the user. Different types of interactions have different meanings. For example, when every time a song starts to play, the user presses a button that causes the song to skip this indicates that it is very likely the user does not like the song. This will prompt the Library Manager 109 to remove the song from the library or to prompt a user to see if they would like to remove the song from the library. As another example, when a user turns up the volume every time a specific song is played, this indicates that a volume setting associated with the specific song should be changed. This occurs because unintentionally, different audio tracks may be recorded at different sound levels. In this manner, after the volume setting associated with the song has been modified, the song will play back in the future at the proper sound level without the need for user interaction.

As a further example, if a user skips every song that plays that has a genre of “Rock” music, the Library Manager 109 utilize this data to aid in editing the music library. Similarly, if a user skips every song by a specific artist, the Library Manager 109 utilizes this data to remove all songs by the artist from the library or to prompt a user with a suggestion to remove all songs by the artist from the library. Note that to remove songs from the library does not necessarily mean to delete them permanently from storage. In one embodiment, removing the songs moves the songs to a folder that includes inactive content or simply flags the songs for possible future deletion.

In yet another example, on a live album, some tracks have song introductions or other commentary in between tracks. Typically, the introduction of a song occurs at the end of the prior track, so when a track is selected it starts playing the song right away rather than the introduction. When playing the album straight through (not shuffled by songs), the entire track for each song is played. However, when the songs are shuffled (i.e., not played in order) there is the effect where when a song ends, the introduction for the next song starts to play and then the track ends abruptly without playing the song the introduction was for. In one embodiment, the Library Manager 109 includes a feature where the user can specify to start or end the track playback some number of seconds late or early (respectively). Thus, for example, the introduction for the next song can be skipped when playing the track in isolation. Therefore, if during playback of a song a user skips to the next track when the current track is has almost ended, that would be a signal to the Library Manager 109 that that song needs to have the “end early” time adjusted when the song is played in a shuffled order. Thus, the Library Agent 214 would record the skip track event near the end of the song. This causes the Library Manager 109 to make or suggest an edit to the music library (i.e., edit the song or to edit the meta data associated with the song).

In an alternative embodiment, as a user is listening to music on the portable audio player 102, by an interaction with input interface 204, the user is able to flag a song. When the portable audio player 102 is reconnected to the computer 100, the Library Manager 109 will receive data that indicates any song which has been flagged. The data indicates to the Library Manager 109 on the computer 100 that changes may need to be made to the audio library. For example, the flag indicates to the Library Manager 109 that an audio file within the library needs modification. Alternatively, the flag indicates to the Library Manager 109 that a prompt should be shown to a user to such that the user can edit an audio file within the library.

The portable audio player 102 includes, in one embodiment, a flag button that is part of the input interface 204. The flag button will flag the current song that is being played back on the portable audio player 102. The flag button is, in one embodiment, a dedicated button. However, different manners of flagging a song are also utilized in alternative embodiments. For example, a button that is normally used to pause a song, will flag a song if the button is held down for more than three seconds. In this manner, a user is able to easily mark any song that needs some modification. Later, when the portable audio player is connected to the computer 100, the Library Manager 109 will display a list of all of the songs the user has flagged. Alternatively, the Library Manager 109 can place an icon next to all of the songs that have been flagged such that the flagged songs can be sorted and distinguished from all of the songs in the music library. The Library Manager 109, in one embodiment, allows a user to sort a list of songs by whether they have been flagged or left not flagged. The user can then selected one or more of the flagged songs and edit the song as needed. For example, a song may need a volume adjustment, it may need to be deleted from the library, the song may need to be rerecorded from a compact disk using a different encoding scheme or bit-rate, or the song may need to have the meta data associated with the song changed (for example, associated with a different genre of music). It should be understood that these are only some of the different types of editing that may be needed to be done to a song or the music library.

FIG. 1 has been described in terms of a portable audio player 102. However, the portable audio player 102 is but one example of a media player that can be used in accordance with the embodiments described herein. For example, the media player, in one embodiment, is capable of playing video files or displaying pictures. As a user views the pictures or video files, inputs corresponding to user interactions are recorded and communicated to the Library Manager 109. The Library Manager 109 on the computer then can edit the video files or picture files. For example, picture files can be removed from a picture album after being flagged for deletion or editing through a user interaction with the media player. Editing operations that are appropriate in various embodiments for image data include, for example, cropping and resizing, color adjustments, rotation, and red-eye correction.

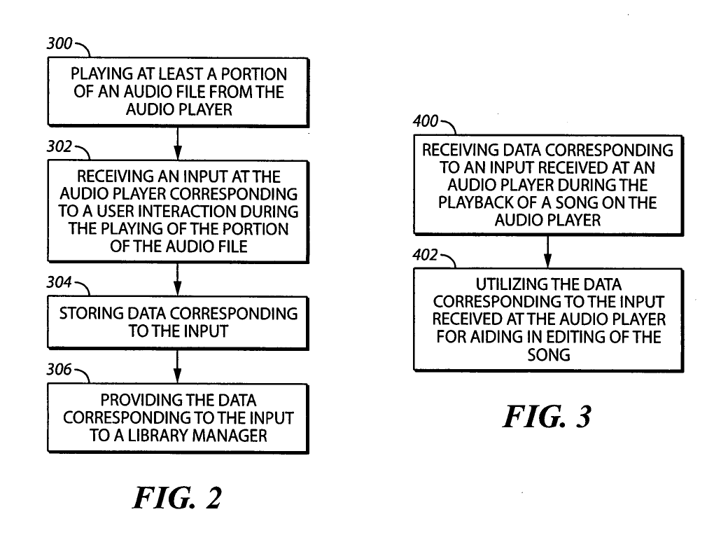

Referring to FIG. 2, shown is a flow diagram illustrating a method of recording data on a media player in accordance with one embodiment. The following steps can be implemented, for example, within circuitry of the media player. As described herein, the circuitry refers to dedicated fixed-purpose circuits and/or partially or wholly programmable platforms of various types, including, for example, hardware, firmware, and/or software.

In optional step 300 at least a portion of a media file is played by the media player. For example, an audio file or video file is played or a picture file is displayed. As referred to herein, a picture file that is displayed is referred to as being played or played back. Alternatively, an introduction to the media file is displayed. For example, a track name or artist name is displayed before playback of an audio file. This indicates the next audio file that will be played back. During the playback of the media file or during the display of the introduction to the media file, in step 302, an input is received at the audio player corresponding to a user interaction. For example, the input received is a command to turn up the volume on the music player or to skip the song that is currently being played by the music player. In step 304 data is stored, for example, in the memory of the audio player that corresponds to the input. For example, the data includes what the input was (key pressed or function executed), what artist and track was playing during the input, and the timing of the input relative to the beginning of the track. The data may also include the time since last input. The time since the last input is used, for example, to detect a series of events that may not be specific to the particular track. An example of the latter is a series of “skip track” events occurring in close succession to one another. The series of inputs most likely does not reflect that the user is avoiding any particular track, but most likely is skipping forward to find a particular track.

The input, as discussed above with reference to FIG. 1, can be through an input interface such as, for example, a button, a keypad, or voice recognition. In one embodiment, the data corresponding to the input is a flag that marks the media file. In another embodiment, all user interactions, their timing, and the artist/track associated with each are recorded in a log file. Timing data is, in one embodiment, as extensive as to include month-day-year, hour-minute-second-millisecond of each event. Next in step 306, the data corresponding to the input is provided to a Library Manager 109. When the Library Manager 109 is on a computer, the media player provides the data corresponding to the input to the Library Manager 109 over a communication interface, such as a communication bus or wireless interface.

Referring next to FIG. 3, shown is a flow diagram illustrating receiving information from a media player for use in editing a media library in accordance with one. embodiment. The following can be implemented by a Library Manager 109, for example, within circuitry of the media player or a computer.

In step 400, data corresponding to an input received at a media player is received by the Library Manager 109. In one embodiment, the input received at the media player corresponds to a user interaction with the media player during the playback of a media file (e.g., an audio file, a video file, and a picture file). Many different types of user interactions can be recorded for utilization by the Library Manager 109. Some examples of a user interaction are a user skipping over a media file, a user adjusting a volume setting during playback of a media file, and a user flagging the media file. Next in step 402 the data corresponding to the input received at the audio player is utilized by the Library Manager 109 for aiding in making changes to the media file within the library. For example, the Library Manager 109 can automatically effect changes to the library, for example, by deleting the media file or changing metadata associated with the media file (for example when the media file is an audio file, a volume setting associated with the song is changed). Alternatively, the Library Manager 109 utilizes the data to flag a song or to prompt a user to edit the song. Editing functions also include, in one embodiment, trimming the beginning and/or ending times of the song, or changing the genre associated with the track or album.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

I claim:

1. A method of data collection for a media player comprising:
receiving an input at the media player corresponding to a user interaction;
storing data corresponding to the input; and
providing the data corresponding to the input to a library manager.

2. A method of claim 1 further comprising storing the recordation of the input as metadata related to the media file.

3. A method of claim 1 wherein the library manager is implemented in circuitry on the media player.

4. A method of claim 1 wherein the library manager is implemented in circuitry on an electronic device.

5. A method of claim 1 further comprising sending the data corresponding to the input to a computer over a communication interface.

6. A method of claim 1 further comprising utilizing the data corresponding to the input for editing a media library.

7. A method of claim 1 further comprising utilizing the data corresponding to the input to prompt a user to edit a media library.

8. A method of claim 1 further comprising utilizing the data corresponding to the input for flagging a file in a media library.

9. A media player device having data collection capabilities comprising:
an interface circuit for receiving an input corresponding to a user interaction;
a processor circuit for monitoring the inputs; and
a memory for storing data corresponding to the input, the data for use by a library manager.

10. The media player device of claim 9 further comprising a data port circuit for transmitting the data corresponding to the input to the library manager.

11. The media player device. of claim 9 wherein the library manager is implemented in circuitry on an electronic device.

12. The media player device of claim 9 wherein the library manager is implemented in circuitry on the media player.

13. The media player device of claim 9 wherein the library manager utilizes the data corresponding to the inputs for automatically editing a media library.

14. The media player device of claim 9 wherein the library manager utilizes the data corresponding to the inputs for prompting a user to make edits to a media library.

15. The media player device of claim 9 wherein the library manager utilizes the data corresponding to the inputs to flag a file within a media library.

16. A method of managing a media library comprising:
receiving data corresponding to an input received at a media player; and
utilizing the data corresponding to the input received at the media player for aiding in editing of a media file.

17. The method of managing a media library of claim 16 wherein the step of utilizing the data corresponding to the input received at the media player for aiding in editing of the media file further comprises prompting a user to edit the media file.

18. The method of managing a media library of claim 16 wherein the step of utilizing the data corresponding to the input received at the media player for aiding in editing of the media file further comprises automatically editing the media file.

19. The method of managing a media library of claim 16 wherein the step of utilizing the data corresponding to the input received at the media player for aiding in editing of the media file further comprises flagging the media file.

20. The method of managing a media library of claim 16 wherein the media library is a music library.
